(19) United States
(12) Patent Application Publication
(10) Pub. No.: US 2004/0148100 A1
(43) Pub. Date: Jul. 29, 2004

(54) Driving route recording-move method and system

(76) Inventor: YingXiang Kang, Fremont, CA (US)

Correspondence Address: Mr. Chein-Hwa Tsao, 6684 Mt Pakron Dr., San Jose, CA, 95120, US

(21) Appl. No.: 10/758,645

(22) Filed: Jan. 14, 2004

Related U.S. Application Data
(60) Provisional application No. 60/440,528, filed on Jan. 17, 2003.

(51) Int. Cl. G05D 1/00

(52) U.S. Cl. 701/210; 701/26

(57) ABSTRACT

A Driving Route Recording-Move System is disclosed to help people back their vehicles more easily and safely. The Driving Route Recording-Move System takes parameter data like the steering wheel rotation angle, moving speed and direction in real time, processes the data and saves them in a file if needed or updates the data. The recording time for the parameter data can be adjusted based on various needs. When the vehicle needs to be backed up, the previously stored data in memory or saved in a file can then be recalled and processed by a control device of the Driving Route Recording-Move System to rotate the steering wheel in a desired direction to a desired angle thus causing the vehicle to back up while following, except in a reverse direction, the same route through which the vehicle came in earlier.

### CROSS REFERENCE TO RELATED APPLICATION

This utility patent application is based upon thus claims the priority of a provisional application Ser. No. 60/440,528, filed Jan. 17, 2003, by the same inventor.

### FIELD OF THE INVENTION

This invention relates to helping people move their vehicles easily. Specifically, the present invention is directed to backing a big vehicle in darkness, when visibility is low, driving on a narrow road or at a complicated location.

### BACKGROUND OF THE INVENTION

Normally, the driver's seat of a vehicle is located either on the right or on the left front of the vehicle thus making driving the vehicle forward easy. However, backing up the vehicle is always difficult especially along a narrow path or at a complicated location (see FIG. 1). Under these circumstances, I assume that most people will be in trouble including professional drivers. The reason is, simply, that one will lose one's ability to see clearly or to use references. In most cases, one needs to back out after one drives in. Therefore, if we can follow exactly the same route, from which we came, we may prevent accident. Hence, it will be more convenient to back out and backing out can even be easy and fun.

### SUMMARY OF THE INVENTION

The present invention aims to help people back their vehicles more easily and safely wherever they are and regardless of the road condition.

The present invention, a Driving Route Recording-Move System, takes parameter data like the steering wheel rotation angle, moving speed and direction in real time, processes the data, saves them in a file if needed or updates the data.

The recording time for the parameter data can be adjusted based on a variety of needs.

When the vehicle needs to be backed up, the previously stored data in memory or saved in a file can be recalled so that a control device of the Driving Route Recording-Move System can process all the recalled data and can therefore rotate the steering wheel in a desired direction to a desired angle thus causing the vehicle to back up while following, in a reverse direction, exactly the same route through which the vehicle came in.

Other objects, together with the foregoing, are attained in the exercise of the invention in the following description and resulting in the embodiment illustrated in the accompanying drawings.

### BRIEF DESCRIPTION OF DRAWINGS

The current invention will be better understood and the nature of the objects set forth above will become apparent when consideration is given to the following detailed description of the preferred embodiments. For clarity of explanation, the detailed description further makes reference to the attached drawings herein:

FIG. 1 illustrates a complicated road along which a vehicle moves;

FIG. 2 illustrates an embodiment of the present invention, a Driving Route Recording-Move System, in the form of a process flowchart for backing up a vehicle; and

FIG. 3 illustrates a particular embodiment of the configuration and function of the Driving Route Recording-Move System.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessary obscuring aspects of the present invention. The detailed description is presented largely in terms of logic blocks and other symbolic representations. These descriptions and representations are the means used by those skilled in the art to concisely and most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations of the invention.

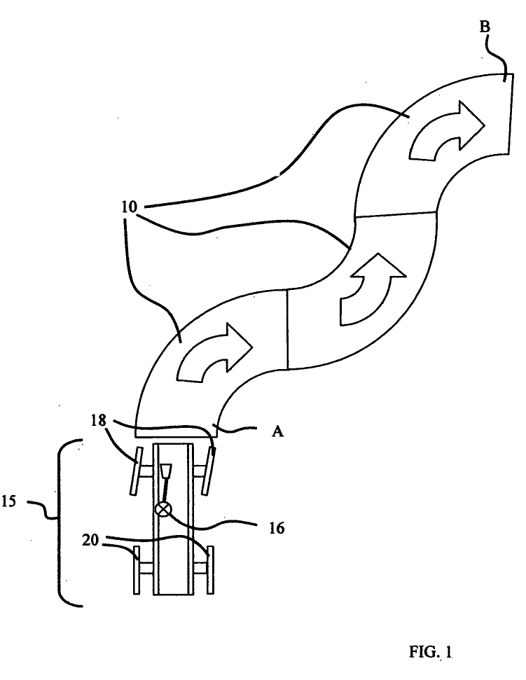

FIG. 1 illustrates a complicated road 10 along which a vehicle 15 moves from point A to point B in a forward direction. It can be seen that the path that the vehicle 15 takes are affected by its front wheels 18 and rear wheels 20 with the front wheels 18 further controlled by a steering wheel 16.

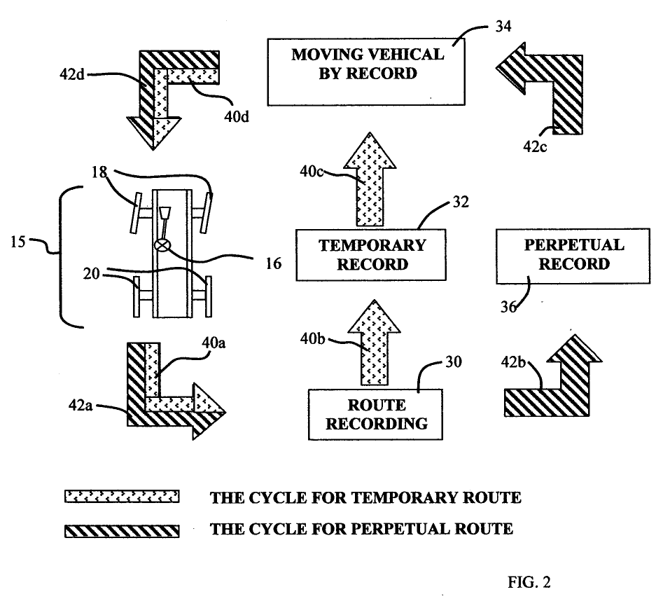

FIG. 2 illustrates an embodiment of the present invention, the Driving Route Recording-Move System, in the form of a process flowchart for backing up a vehicle. During driving of the vehicle 15, the Driving Route Recording-Move System takes data (parameters) of the steering wheel rotated angle, moving speed and direction in real time. The Driving Route Recording-Move System further processes the data saved in a file if needed, or update the data. The recording time can be adjusted based on need. The data may be collected from the steering wheel, the rod of the steering wheel, the front wheel system or any parts engaged the vehicle turning process. As shown in FIG. 2, two route recording cycles are implemented. A cycle for temporary route recording includes a cycle segment for temporary route 40a, a route recording 30, a cycle segment for temporary route 40b, a temporary record 32, a cycle segment for temporary route 40c, a moving vehicle by record 34 and a cycle segment for temporary route 40d. On the other hand, a cycle for perpetual route recording includes a cycle segment for perpetual route 42a, the route recording 30, the cycle segment for perpetual route 42b, a perpetual record 36, a cycle segment for perpetual route 42c, the moving vehicle by record 34 and a cycle segment for perpetual route 42d.

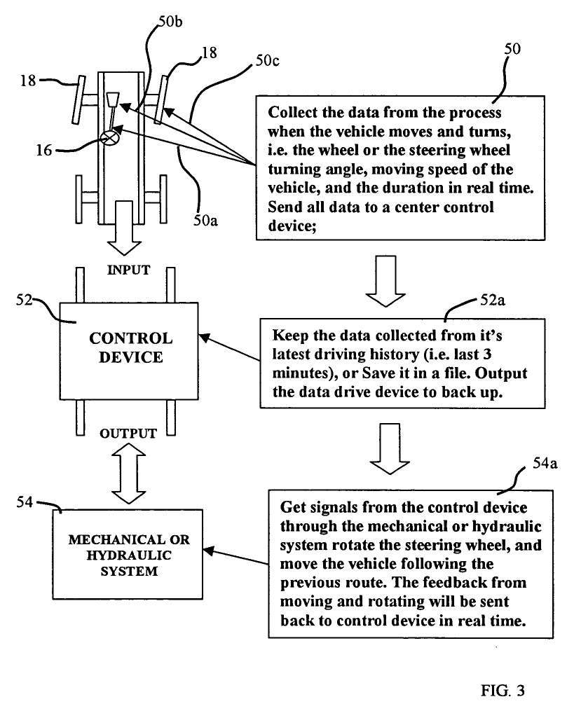

FIG. 3 illustrates a particular embodiment of the configuration and function of the driving Route Recording-Move System. A control device 52 is provided that accepts various input data from the vehicle 15 as indicated by data source 50a, data source 50b and data source 50c. The control device 52 also has a bi-directional output interface with a mechanical or hydraulic system 54 of the vehicle 15. Thus, the control device 52 collects various data from a process wherein the vehicle 15 moves and turns. The various data include the turning angle of the wheel or the steering wheel 16, moving speed of the vehicle 15 and the duration in real time. All the collected data are sent, as signified by a collect and send data 50, to the control device 52. Furthermore, the collected data are kept from the latest driving history of the vehicle 15, i.e., for the last 3 minutes. Also, the collected data can be saved in a file as signified by a control device activity 52a. Thus, when the vehicle 15 needs to be backed up, the collected data stored in memory or saved in a file can be recalled and processed by the control device 52 so that it can rotate the steering wheel 16 to the angle and direction desired thus backing up the vehicle 15 by following exactly the same route copied from when it first moved forward. More specifically, signals are sent from the control device 52 through the mechanical or hydraulic system 54 to rotate the steering wheel 16 and move the vehicle 15 following the previous route. Additionally, the feedback from moving and rotating will be sent back to the control device 52 in real time as signified by a mechanical or hydraulic activity 54a. Thus, the wheels will be turned by the mechanical or hydraulic system-close loop system engaged.

As described, a Driving Route Recording-Move System of the present invention is disclosed to help people back up their vehicles. The Driving Route Recording-Move System takes parameter data like the steering wheel rotation angle, moving speed and direction in real time, processes, updates and saves the data in a file. During vehicle back up, the saved data can then be recalled and processed by a control device to rotate the steering wheel in a desired direction to a desired angle thus causing the vehicle to back up while following, except in a reverse direction, the same route through which the vehicle came in earlier. The invention has been described using exemplary preferred embodiments. However, for those skilled in this field, the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

What is claimed is:

1. A method of reversing a latest route through which a vehicle was driven in a first direction, the method comprising:
(a) while the vehicle was driven along said latest route in the first direction, collecting a set of parameter data controlling said latest route; and
(b) upon a demand of reversing said latest route hence driving the vehicle in a second direction along the same route, recalling, processing said parameter data set and using the processed parameter data set to control the reversing of said latest route.

2. The method of claim 1 wherein said parameter data set further comprises a steering wheel rotation angle, a turning angle of the wheels, vehicle moving speed, vehicle direction and an elapsed driving time.

3. The method of claim 1 wherein said collecting of parameter data set is carried out in real time.

4. The method of claim 1 wherein controlling the reversing of said latest route is carried out in real time.

5. The method of claim 1 wherein step (a) further comprises updating said parameter data set while the vehicle was driven in the first direction.

6. The method of claim 1 wherein step (a) further comprises recording the collected parameter data set for a latest driving history of the vehicle.

7. The method of claim 6 wherein said latest driving history is adjustable.

8. The method of claim 6 wherein said latest driving history is a driving distance or a driving time.

9. The method of claim 8 wherein said driving distance is from about 1 ft to about 1000 ft.

10. The method of claim 8 wherein said driving time is from about 1 second to about 10 minutes.

11. The method of claim 1 wherein step (a) further comprises saving said parameter data set in a memory or a file.

12. A Driving Route Recording-Move System (DRRM) for reversing a latest route through which a vehicle was driven in a first direction, the DRRM comprising:
(a) a control device coupled to the vehicle for collecting a set of parameter data controlling said latest route and for controlling said reversing a latest route; and
(b) a process control means for:
(b1) while the vehicle was driven in the first direction, collecting said parameter data set; and
(b2) upon a demand of reversing said latest route hence driving the vehicle in a second direction along the same route, recalling, processing said parameter data set and using the processed parameter data set to control the reversing of said latest route.

13. The DRRM of claim 12 wherein the coupling between the control device and the vehicle is through a bi-directional interface.

14. The DRRM of claim 12 wherein the control device is coupled to any parts of said vehicle engaged in the vehicle turning process.

15. The DRRM of claim 14 wherein the control device is coupled to a steering wheel.

16. The DRRM of claim 15 wherein controlling the reversing of said latest route is by rotating the steering wheel in a desired direction to a desired angle.

17. The DRRM of claim 12 wherein the control device is coupled to a mechanical system of said vehicle.

18. The DRRM of claim 17 wherein the control device is coupled to a rod of a steering wheel.

19. The DRRM of claim 17 wherein the control device is coupled to a front wheel system.

20. The DRRM of claim 12 wherein the control device is coupled to a hydraulic system of said vehicle.

21. The DRRM of claim 12 wherein said parameter data set further comprises a steering wheel rotation angle, a turning angle of the wheels, vehicle moving speed, vehicle direction and an elapsed driving time.

22. The DRRM of claim 12 wherein said collecting of parameter data set is carried out in real time.

23. The DRRM of claim 12 wherein controlling the reversing of said latest route is carried out in real time.

24. The DRRM of claim 12 wherein collecting said parameter data set of the process control means further comprises updating said parameter data set while the vehicle was driven in the first direction.

25. The DRRM of claim 12 wherein collecting said parameter data set of the process control means further comprises recording the collected parameter data set for a latest driving history of the vehicle.

26. The DRRM of claim 25 wherein said latest driving history is adjustable.

27. The DRRM of claim 25 wherein said latest driving history is a driving distance or a driving time.

28. The DRRM of claim 27 wherein said driving distance is from about 1 ft to about 1000 ft.

29. The DRRM of claim 27 wherein said driving time is from about 1 second to about 10 minutes.

30. The DRRM of claim 12 wherein collecting said parameter data set of the process control means further comprises saving said parameter data set in a memory or a file.

31. The DRRM of claim 12 wherein controlling the reversing of said latest route is through a closed-loop system.
